(19) United States
(12) Patent Application Publication
(10) Pub. No.: US 2026/0188327 A1
(43) Pub. Date: Jul. 2, 2026

(54) ARTIFICIAL INTELLIGENCE DEVICE AND AUTOMATIC SPEAKER RECOGNITION METHOD THEREFOR

(71) Applicant: LG ELECTRONICS INC., Seoul (KR)

(72) Inventors: Eunkyung RYU, Seoul (KR); Taehyeong KIM, Seoul (KR); Hyeonseop SONG, Seoul (KR)

(73) Assignee: LG ELECTRONICS INC., Seoul (KR)

(21) Appl. No.: 18/858,696

(22) PCT Filed: Mar. 28, 2023
(86) PCT No.: PCT/KR2023/004106

§ 371 Date: Oct. 21, 2024

(30) Foreign Application Priority Data
Apr. 22, 2022 (KR) 10-2022-0050442
Mar. 24, 2023 (KR) 10-2023-0038748

(51) Int. Cl. G10L 17/26; G10L 17/02; G10L 17/04; G10L 17/06; G10L 17/18

(52) U.S. Cl. CPC G10L 17/26; G10L 17/02; G10L 17/04; G10L 17/06; G10L 17/18

(57) ABSTRACT

The present disclosure relates to an artificial intelligence apparatus capable of automatically recognizing a speaker based on adaptive self-learning through active query, and a method for automatically recognizing a speaker thereof, and the artificial intelligence apparatus includes a memory storing a list of pre-learned speakers; and, a processor identifying a new speaker from input utterance data, in which the processor may preprocess the utterance data when the utterance data is input, identify a new speaker based on the pre-processed utterance data, output an active query for the identified new speaker, and when response utterance data of the new speaker to the output active query is input, learn the new speaker based on the response utterance data of the new speaker and register the new speaker in the speaker list.

### TECHNICAL FIELD

The present disclosure relates to an artificial intelligence apparatus capable of automatically recognizing a speaker based on adaptive self-learning through active query, and a method for automatically recognizing a speaker thereof.

### BACKGROUND ART

In general, artificial intelligence is a field of computer science and information technology that studies ways to enable computers to do things like thinking, learning, and self-development that can be done with human intelligence, and means enabling computers to imitate human intelligent behavior.

In addition, artificial intelligence does not exist in itself, but is directly or indirectly related to other fields of computer science. In particular, in modern times, attempts are being made to introduce artificial intelligence elements into various fields of information technology and utilize them to solve problems in those fields very actively.

Meanwhile, technologies that use artificial intelligence to recognize and learn the surrounding situation, provide the user with the information they want in the desired format, or perform actions or functions they want are being actively researched.

In addition, an electronic device that provides these various operations and functions can be referred to as an artificial intelligence apparatus.

Recently, home appliances such as voice assistants are providing services that recognize users' voice commands through artificial intelligence technology and perform tasks corresponding to the voice commands.

The artificial intelligence models of home appliances that provide these services can perform speaker recognition to provide personalized services to each individual.

In particular, in a home environment where there are multiple speakers, a speaker registration procedure is absolutely necessary in advance for individual speaker recognition by the artificial intelligence model.

In other words, in order to provide personalized services through voice assistants, the AI model must identify the speaker using only voice data, so users are required to go through an initial registration procedure before using the service.

This initial registration procedure had the problem of taking a lot of time because it had to be carried out in a situation where there was no voice data for the new speaker, and since unregistered users had restrictions on using the service, there was the inconvenience of having to go through the registration procedure every time a new user was added.

In this way, the artificial intelligence model of a home appliance that provides a service may not be able to provide a corresponding service when a new user suddenly requests a service in a home environment where the number of members using the service and the total number of members are unknown.

Therefore, in the future, it is necessary to develop artificial intelligence technology that can improve service quality by automatically recognizing new speakers and automatically registering new speakers at any time without requiring additional user registration procedures.

### DISCLOSURE

### Technical Problem

An object of the present disclosure is to solve the above-mentioned problems and other problems.

An object of the present disclosure is to provide an artificial intelligence apparatus that can improve speaker recognition accuracy and service quality by automatically learning utterance data of a new speaker and automatically registering the new speaker in a speaker list by providing an active query to the new speaker together with an uncertainty measure for the input utterance data, and a method for automatically recognizing a speaker thereof.

### Technical Solution

An artificial intelligence apparatus according to an embodiment of the present disclosure includes a memory storing a list of pre-learned speakers; and, a processor identifying a new speaker from input utterance data, in which the processor may preprocess the utterance data when the utterance data is input, identifies a new speaker based on the pre-processed utterance data, output an active query for the identified new speaker, and when response utterance data of the new speaker to the output active query is input, learn the new speaker based on the response utterance data of the new speaker and register the new speaker in the speaker list.

A method for automatically recognizing speaker of an artificial intelligence apparatus according to an embodiment of the present disclosure may include inputting a speaker's utterance data; preprocessing the speaker's utterance data; identifying a new speaker based on the preprocessed utterance data; outputting an active query for the new speaker if the new speaker is identified; inputting the new speaker's response utterance data for the active query; learning the new speaker based on the new speaker's response utterance data; and registering the learned new speaker in a speaker list.

### Advantageous Effect

According to one embodiment of the present disclosure, an artificial intelligence apparatus can improve speaker recognition accuracy and service quality by automatically learning utterance data of a new speaker and automatically registering the new speaker in a speaker list by providing an active query to a new speaker along with an uncertainty measure for input utterance data.

### DESCRIPTION OF DRAWINGS

FIG. 1 illustrates an artificial intelligence apparatus according to an embodiment of the present disclosure.

FIG. 2 illustrates an artificial intelligence server according to an embodiment of the present disclosure.

FIG. 3 illustrates an artificial intelligence system according to an embodiment of the present disclosure.

FIG. 4 is a view for explaining the operation of an artificial intelligence apparatus according to one embodiment of the present disclosure.

FIG. 5 is a view for explaining a method for adding a new speaker to an artificial intelligence apparatus according to an embodiment of the present disclosure.

FIGS. 6 to 14 are views for explaining a neural network model of an artificial intelligence apparatus according to an embodiment of the present disclosure.

FIG. 15 is a view for explaining a new speaker registration process of an artificial intelligence apparatus according to one embodiment of the present disclosure.

FIGS. 16 to 18 are views illustrating speaker recognition accuracy performance results for a neural network model of an artificial intelligence apparatus according to an embodiment of the present disclosure.

FIG. 19 and FIG. 20 are views for explaining the overall operation flow of an artificial intelligence apparatus according to one embodiment of the present disclosure.

### BEST MODE

Hereinafter, embodiments of the present disclosure are described in more detail with reference to accompanying drawings and regardless of the drawings symbols, same or similar components are assigned with the same reference numerals and thus overlapping descriptions for those are omitted. The suffixes “module” and “unit” for components used in the description below are assigned or mixed in consideration of easiness in writing the specification and do not have distinctive meanings or roles by themselves. In the following description, detailed descriptions of well-known functions or constructions will be omitted since they would obscure the disclosure in unnecessary detail. Additionally, the accompanying drawings are used to help easily understanding embodiments disclosed herein but the technical idea of the present disclosure is not limited thereto. It should be understood that all of variations, equivalents or substitutes contained in the concept and technical scope of the present disclosure are also included.

It will be understood that the terms “first” and “second” are used herein to describe various components but these components should not be limited by these terms. These terms are used only to distinguish one component from other components.

In this disclosure below, when one part (or element, device, etc.) is referred to as being ‘connected’ to another part (or element, device, etc.), it should be understood that the former can be ‘directly connected’ to the latter, or ‘electrically connected’ to the latter via an intervening part (or element, device, etc.). It will be further understood that when one component is referred to as being ‘directly connected’ or ‘directly linked’ to another component, it means that no intervening component is present.

Also, throughout this specification, a neural network and a network function may be used interchangeably. The neural network may be constituted by a set of interconnected computational units, which may be generally referred to as “nodes”. These “nodes” may also be referred to as “neurons”. The neural network is configured to include at least two or more nodes. Nodes (or neurons) constituting neural networks may be interconnected by one or more “links”.

### <Artificial Intelligence (AI)>

Artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

An artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value.

The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function.

The purpose of the learning of the artificial neural network may be to determine the model parameters that minimize a loss function. The loss function may be used as an index to determine optimal model parameters in the learning process of the artificial neural network.

Machine learning may be classified into supervised learning, unsupervised learning, and reinforcement learning according to a learning method.

The supervised learning may refer to a method of training an artificial neural network in a state in which a label for learning data is given, and the label may mean the correct answer (or result value) that the artificial neural network must infer when the learning data is input to the artificial neural network. The unsupervised learning may refer to a method of training an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and the deep learning is part of machine learning. In the following, machine learning is used to mean deep learning.

### <Robot>

A robot may refer to a machine that automatically processes or operates a given task by its own ability. In particular, a robot having a function of recognizing an environment and performing a self-determination operation may be referred to as an intelligent robot.

Robots may be classified into industrial robots, medical robots, home robots, military robots, and the like according to the use purpose or field.

The robot includes a driving unit may include an actuator or a motor and may perform various physical operations such as moving a robot joint. In addition, a movable robot may include a wheel, a brake, a propeller, and the like in a driving unit, and may travel on the ground through the driving unit or fly in the air.

### <Self-Driving>

Self-driving refers to a technique of driving for oneself, and a self-driving vehicle refers to a vehicle that travels without an operation of a user or with a minimum operation of a user.

For example, the self-driving may include a technology for maintaining a lane while driving, a technology for automatically adjusting a speed, such as adaptive cruise control, a technique for automatically traveling along a predetermined route, and a technology for automatically setting and traveling a route when a destination is set.

The vehicle may include a vehicle having only an internal combustion engine, a hybrid vehicle having an internal combustion engine and an electric motor together, and an electric vehicle having only an electric motor, and may include not only an automobile but also a train, a motorcycle, and the like.

In this case, the self-driving vehicle may be regarded as a robot having a self-driving function.

<eXtended Reality (XR)>

Extended reality is collectively referred to as virtual reality (VR), augmented reality (AR), and mixed reality (MR). The VR technology provides a real-world object and background only as a CG image, the AR technology provides a virtual CG image on a real object image, and the MR technology is a computer graphic technology that mixes and combines virtual objects into the real world.

The MR technology is similar to the AR technology in that the real object and the virtual object are illustrated together. However, in the AR technology, the virtual object is used in the form that complements the real object, whereas in the MR technology, the virtual object and the real object are used in an equal manner.

The XR technology may be applied to a head-mount display (HMD), a head-up display (HUD), a mobile phone, a tablet PC, a laptop, a desktop, a TV, a digital signage, and the like. A device to which the XR technology is applied may be referred to as an XR device.

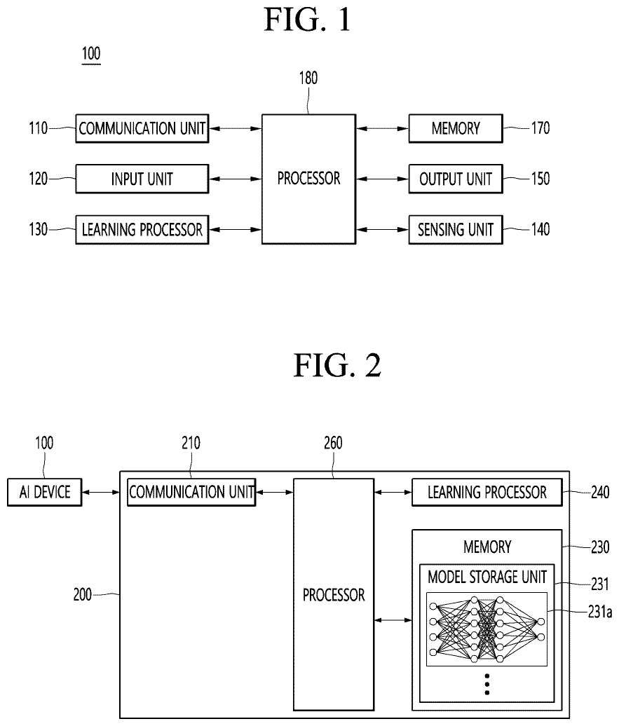

FIG. 1 illustrates an AI device 100 according to an embodiment of the present disclosure.

The AI device (or an AI apparatus) 100 may be implemented by a stationary device or a mobile device, such as a TV, a projector, a mobile phone, a smartphone, a desktop computer, a notebook, a digital broadcasting terminal, a personal digital assistant (PDA), a portable multimedia player (PMP), a navigation device, a tablet PC, a wearable device, a set-top box (STB), a DMB receiver, a radio, a washing machine, a refrigerator, a desktop computer, a digital signage, a robot, a vehicle, and the like.

Referring to FIG. 1, the AI device 100 may include a communication unit 110, an input unit 120, a learning processor 130, a sensing unit 140, an output unit 150, a memory 170, and a processor 180.

The communication unit 110 may transmit and receive data to and from external devices such as other AI devices 100a to 100e and the AI server 200 by using wire/wireless communication technology. For example, the communication unit 110 may transmit and receive sensor information, a user input, a learning model, and a control signal to and from external devices.

The communication technology used by the communication unit 110 includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 120 may acquire various kinds of data.

In this case, the input unit 120 may include a camera for inputting a video signal, a microphone for receiving an audio signal, and a user input unit for receiving information from a user. The camera or the microphone may be treated as a sensor, and the signal acquired from the camera or the microphone may be referred to as sensing data or sensor information.

The input unit 120 may acquire a learning data for model learning and an input data to be used if an output is acquired by using learning model. The input unit 120 may acquire raw input data. In this case, the processor 180 or the learning processor 130 may extract an input feature by preprocessing the input data.

The learning processor 130 may learn a model composed of an artificial neural network by using learning data. The learned artificial neural network may be referred to as a learning model. The learning model may be used to an infer result value for new input data rather than learning data, and the inferred value may be used as a basis for determination to perform a certain operation.

At this time, the learning processor 130 may perform AI processing together with the learning processor 240 of the AI server 200 of FIG. 2.

At this time, the learning processor 130 may include a memory integrated or implemented in the AI device 100. Alternatively, the learning processor 130 may be implemented by using the memory 170, an external memory directly connected to the AI device 100, or a memory held in an external device.

The sensing unit 140 may acquire at least one of internal information about the AI device 100, ambient environment information about the AI device 100, and user information by using various sensors.

Examples of the sensors included in the sensing unit 140 may include a proximity sensor, an illuminance sensor, an acceleration sensor, a magnetic sensor, a gyro sensor, an inertial sensor, an RGB sensor, an IR sensor, a fingerprint recognition sensor, an ultrasonic sensor, an optical sensor, a microphone, a lidar, and a radar.

The output unit 150 may generate an output related to a visual sense, an auditory sense, or a haptic sense.

At this time, the output unit 150 may include a display unit for outputting time information, a speaker for outputting auditory information, and a haptic module for outputting haptic information.

The memory 170 may store data that supports various functions of the AI device 100. For example, the memory 170 may store input data acquired by the input unit 120, learning data, a learning model, a learning history, and the like.

The processor 180 may determine at least one executable operation of the AI device 100 based on information determined or generated by using a data analysis algorithm or a machine learning algorithm. The processor 180 may control the components of the AI device 100 to execute the determined operation.

To this end, the processor 180 may request, search, receive, or utilize data of the learning processor 130 or the memory 170. The processor 180 may control the components of the AI device 100 to execute the predicted operation or the operation determined to be desirable among the at least one executable operation.

When the connection of an external device is required to perform the determined operation, the processor 180 may generate a control signal for controlling the external device and may transmit the generated control signal to the external device.

The processor 180 may acquire intention information for the user input and may determine the user's requirements based on the acquired intention information.

The processor 180 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 130, may be learned by the learning processor 240 of the AI server 200, or may be learned by their distributed processing.

The processor 180 may collect history information including the operation contents of the AI apparatus 100 or the user's feedback on the operation and may store the collected history information in the memory 170 or the learning processor 130 or transmit the collected history information to the external device such as the AI server 200. The collected history information may be used to update the learning model.

The processor 180 may control at least part of the components of AI device 100 so as to drive an application program stored in the memory 170. Furthermore, the processor 180 may operate two or more of the components included in the AI device 100 in combination so as to drive the application program.

FIG. 2 illustrates an AI server 200 according to an embodiment of the present disclosure.

Referring to FIG. 2, the AI server 200 may refer to a device that learns an artificial neural network by using a machine learning algorithm or uses a learned artificial neural network/The AI server 200 may include a plurality of servers to perform distributed processing or may be defined as a 5G network. In this case, the AI server 200 may be included as a partial configuration of the AI device 100, and may perform at least part of the AI processing together.

The AI server 200 may include a communication unit 210, a memory 230, a learning processor 240, a processor 260, and the like.

The communication unit 210 may transmit and receive data to and from an external device such as the AI device 100.

The memory 230 may include a model storage unit 231. The model storage unit 231 may store a learning or learned model (or an artificial neural network 231a) through the learning processor 240.

The learning processor 240 may learn the artificial neural network 231a by using the learning data. The learning model may be used in a state of being mounted on the AI server 200 of the artificial neural network, or may be used in a state of being mounted on an external device such as the AI device 100.

The learning model may be implemented in hardware, software, or a combination of hardware and software. If all or part of the learning models are implemented in software, one or more instructions that constitute the learning model may be stored in memory 230.

The processor 260 may infer the result value for new input data by using the learning model and may generate a response or a control command based on the inferred result value.

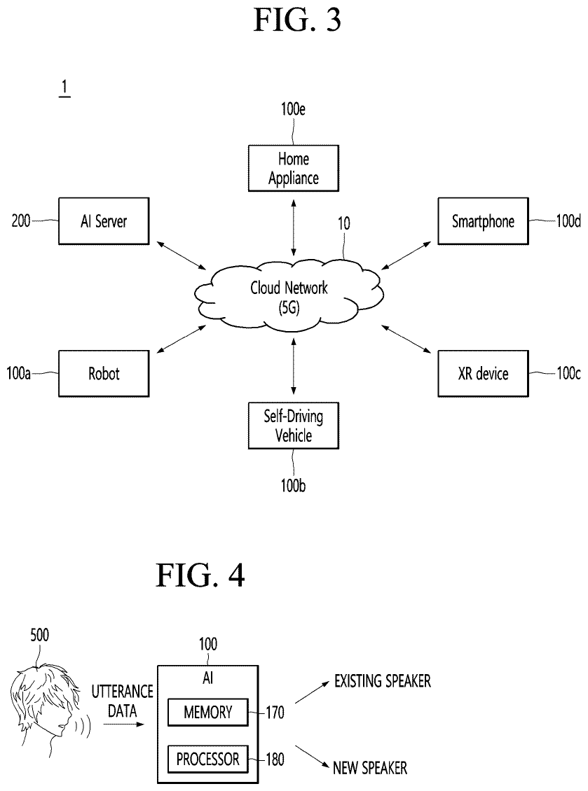

FIG. 3 is a view of an AI system 1 according to an embodiment of the present invention.

Referring to FIG. 3, in the AI system 1, at least one of an AI server 200, a robot 100a, a self-driving vehicle 100b, an XR device 100c, a smartphone 100d, or a home appliance 100e is connected to a cloud network 10. The robot 100a, the self-driving vehicle 100b, the XR device 100c, the smartphone 100d, or the home appliance 100e, to which the AI technology is applied, may be referred to as AI devices 100a to 100e.

The cloud network 10 may refer to a network that forms part of a cloud computing infrastructure or exists in a cloud computing infrastructure. The cloud network 10 may be configured by using a 3G network, a 4G or LTE network, or a 5G network.

In other words, the devices 100a to 100e and 200 configuring the AI system 1 may be connected to each other through the cloud network 10.

The AI server 200 may include a server that performs AI processing and a server that performs operations on big data.

The AI server 200 may be connected to at least one of the AI devices constituting the AI system 1, that is, the robot 100a, the self-driving vehicle 100b, the XR device 100c, the smartphone 100d, or the home appliance 100e through the cloud network 10, and may assist at least part of AI processing of the connected AI devices 100a to 100e.

At this time, the AI server 200 may learn the artificial neural network according to the machine learning algorithm instead of the AI devices 100a to 100e, and may directly store the learning model or transmit the learning model to the AI devices 100a to 100e.

At this time, the AI server 200 may receive input data from the AI devices 100a to 100e, may infer the result value for the accommodated input data by using the learning model, may generate a response or a control command based on the inferred result value, and may transmit the response or the control command to the AI devices 100a to 100e.

Alternatively, the AI devices 100a to 100e may infer the result value for the input data by directly using the learning model, and may generate the response or the control command based on the inference result.

Hereinafter, various embodiments of the AI devices 100a to 100e to which the above-described technology is applied will be described. The AI devices 100a to 100e illustrated in FIG. 3 may be regarded as a specific embodiment of the AI device 100 illustrated in FIG. 1.

### <AI+Robot>

The robot 100a, to which the AI technology is applied, may be implemented as a guide robot, a carrying robot, a cleaning robot, a wearable robot, an entertainment robot, a pet robot, an unmanned flying robot, or the like.

The robot 100a may include a robot control module for controlling the operation, and the robot control module may refer to a software module or a chip implementing the software module by hardware.

The robot 100a may acquire state information about the robot 100a by using sensor information acquired from various kinds of sensors, may detect (recognize) surrounding environment and objects, may generate map data, may determine the route and the travel plan, may determine the response to user interaction, or may determine the operation.

The robot 100a may use the sensor information acquired from at least one sensor among the lidar, the radar, and the camera so as to determine the travel route and the travel plan.

The robot 100a may perform the above-described operations by using the learning model provided as at least one artificial neural network. For example, the robot 100a may recognize the surrounding environment and the objects by using the learning model, and may determine the operation by using the recognized surrounding information or object information. The learning model may be learned directly from the robot 100a or may be learned from an external device such as the AI server 200.

At this time, the robot 100a may perform the operation by generating the result by directly using the learning model, but the sensor information may be transmitted to the external device such as the AI server 200 and the generated result may be accommodated to perform the operation.

The robot 100a may use at least one of the map data, the object information detected from the sensor information, or the object information acquired from the external apparatus to determine the travel route and the travel plan, and may control the driving unit such that the robot 100a travels along the determined travel route and travel plan.

The map data may include object identification information about various objects arranged in the space in which the robot 100a moves. For example, the map data may include object identification information about fixed objects such as walls and doors and movable objects such as pollen and desks. The object identification information may include a name, a type, a distance, and a position.

In addition, the robot 100a may perform the operation or travel by controlling the driving unit based on the control/interaction of the user. At this time, the robot 100a may acquire the intention information of the interaction due to the user's operation or speech utterance, and may determine the response based on the acquired intention information, and may perform the operation.

### <AI+Self-Driving>

The self-driving vehicle 100b, to which the AI technology is applied, may be implemented as a mobile robot, a vehicle, an unmanned flying vehicle, or the like.

The self-driving vehicle 100b may include a self-driving control module for controlling a self-driving function, and the self-driving control module may refer to a software module or a chip implementing the software module by hardware. The self-driving control module may be included in the self-driving vehicle 100b as a component thereof, but may be implemented with separate hardware and connected to the outside of the self-driving vehicle 100b.

The self-driving vehicle 100b may acquire state information about the self-driving vehicle 100b by using sensor information acquired from various kinds of sensors, may detect (recognize) surrounding environment and objects, may generate map data, may determine the path and the travel plan, or may determine the operation.

Like the robot 100a, the self-driving vehicle 100b may use the sensor information acquired from at least one sensor among the lidar, the radar, and the camera so as to determine the travel path and the travel plan.

In particular, the self-driving vehicle 100b may recognize the environment or objects for an area covered by a field of view or an area over a certain distance by receiving the sensor information from external devices, or may receive directly recognized information from the external devices.

The self-driving vehicle 100b may perform the above-described operations by using the learning model composed of at least one artificial neural network. For example, the self-driving vehicle 100b may recognize the surrounding environment and the objects by using the learning model, and may determine the traveling movement line by using the recognized surrounding information or object information. The learning model may be learned directly from the self-driving vehicle 100a or may be learned from an external device such as the AI server 200.

In this case, the self-driving vehicle 100b may perform the operation by generating the result by directly using the learning model, but the sensor information may be transmitted to the external device such as the AI server 200 and the generated result may be received to perform the operation.

The self-driving vehicle 100b may use at least one of the map data, the object information detected from the sensor information, or the object information acquired from the external apparatus to determine the travel path and the travel plan, and may control the driving device such that the self-driving vehicle 100b travels along the determined travel path and travel plan.

The map data may include object identification information about various objects arranged in the space (for example, road) in which the self-driving vehicle 100b travels. For example, the map data may include object identification information about fixed objects such as street lamps, rocks, and buildings and movable objects such as vehicles and pedestrians. The object identification information may include a name, a type, a distance, and a position.

In addition, the self-driving vehicle 100b may perform the operation or travel by controlling the driving device based on the control/interaction of the user. In this case, the self-driving vehicle 100b may acquire the intention information of the interaction due to the user's operation or speech utterance, and may determine the response based on the acquired intention information, and may perform the operation.

### <AI+XR>

The XR device 100c, to which the AI technology is applied, may be implemented by a head-mount display (HMD), a head-up display (HUD) provided in the vehicle, a television, a mobile phone, a smartphone, a computer, a wearable device, a home appliance, a digital signage, a vehicle, a fixed robot, a mobile robot, or the like.

The XR device 100c may analyzes three-dimensional point cloud data or image data acquired from various sensors or the external devices, generate position data and attribute data for the three-dimensional points, acquire information about the surrounding space or the real object, and render to output the XR object to be output. For example, the XR device 100c may output an XR object including the additional information about the recognized object in correspondence to the recognized object.

The XR device 100c may perform the above-described operations by using the learning model composed of at least one artificial neural network. For example, the XR device 100c may recognize the real object from the three-dimensional point cloud data or the image data by using the learning model, and may provide information corresponding to the recognized real object. The learning model may be directly learned from the XR device 100c, or may be learned from the external device such as the AI server 200.

In this case, the XR device 100c may perform the operation by generating the result by directly using the learning model, but the sensor information may be transmitted to the external device such as the AI server 200 and the generated result may be received to perform the operation.

### <AI+Robot+Self-Driving>

The robot 100a, to which the AI technology and the self-driving technology are applied, may be implemented as a guide robot, a carrying robot, a cleaning robot, a wearable robot, an entertainment robot, a pet robot, an unmanned flying robot, or the like.

The robot 100a, to which the AI technology and the self-driving technology are applied, may refer to the robot itself having the self-driving function or the robot 100a interacting with the self-driving vehicle 100b.

The robot 100a having the self-driving function may collectively refer to a device that moves for itself along the given movement line without the user's control or moves for itself by determining the movement line by itself.

The robot 100a and the self-driving vehicle 100b having the self-driving function may use a common sensing method so as to determine at least one of the travel route or the travel plan. For example, the robot 100a and the self-driving vehicle 100b having the self-driving function may determine at least one of the travel route or the travel plan by using the information sensed through the lidar, the radar, and the camera.

The robot 100a that interacts with the self-driving vehicle 100b exists separately from the self-driving vehicle 100b and may perform operations interworking with the self-driving function of the self-driving vehicle 100b or interworking with the user who rides on the self-driving vehicle 100b.

At this time, the robot 100a interacting with the self-driving vehicle 100b may control or assist the self-driving function of the self-driving vehicle 100b by acquiring sensor information on behalf of the self-driving vehicle 100b and providing the sensor information to the self-driving vehicle 100b, or by acquiring sensor information, generating environment information or object information, and providing the information to the self-driving vehicle 100b.

Alternatively, the robot 100a interacting with the self-driving vehicle 100b may monitor the user boarding the self-driving vehicle 100b, or may control the function of the self-driving vehicle 100b through the interaction with the user. For example, when it is determined that the driver is in a drowsy state, the robot 100a may activate the self-driving function of the self-driving vehicle 100b or assist the control of the driving unit of the self-driving vehicle 100b. The function of the self-driving vehicle 100b controlled by the robot 100a may include not only the self-driving function but also the function provided by the navigation system or the audio system provided in the self-driving vehicle 100b.

Alternatively, the robot 100a that interacts with the self-driving vehicle 100b may provide information or assist the function to the self-driving vehicle 100b outside the self-driving vehicle 100b. For example, the robot 100a may provide traffic information including signal information and the like, such as a smart signal, to the self-driving vehicle 100b, and automatically connect an electric charger to a charging port by interacting with the self-driving vehicle 100b like an automatic electric charger of an electric vehicle.

### <AI+Robot+XR>

The robot 100a, to which the AI technology and the XR technology are applied, may be implemented as a guide robot, a carrying robot, a cleaning robot, a wearable robot, an entertainment robot, a pet robot, an unmanned flying robot, a drone, or the like.

The robot 100a, to which the XR technology is applied, may refer to a robot subjected to control/interaction in an XR image. In this case, the robot 100a may be separated from the XR device 100c and interwork with each other.

If the robot 100a, which is subjected to control/interaction in the XR image, may acquire the sensor information from the sensors including the camera, the robot 100a or the XR device 100c may generate the XR image based on the sensor information, and the XR device 100c may output the generated XR image. The robot 100a may operate based on the control signal input through the XR device 100c or the user's interaction.

For example, the user may confirm the XR image corresponding to the time point of the robot 100a interworking remotely through the external device such as the XR device 100c, adjust the self-driving travel path of the robot 100a through interaction, control the operation or driving, or confirm the information about the surrounding object.

### <AI+Self-Driving+XR>

The self-driving vehicle 100b, to which the AI technology and the XR technology are applied, may be implemented as a mobile robot, a vehicle, an unmanned flying vehicle, or the like.

The self-driving vehicle 100b, to which the XR technology is applied, may refer to a self-driving vehicle having a means for providing an XR image or a self-driving vehicle subjected to control/interaction in an XR image. Particularly, the self-driving vehicle 100b In other words subjected to control/interaction in the XR image may be distinguished from the XR device 100c and interwork with each other.

The self-driving vehicle 100b having the means for providing the XR image may acquire the sensor information from the sensors including the camera and output the generated XR image based on the acquired sensor information. For example, the self-driving vehicle 100b may include an HUD to output an XR image, thereby providing a passenger with a real object or an XR object corresponding to an object in the screen.

In this case, if the XR object is output to the HUD, at least part of the XR object may be outputted so as to overlap the actual object to which the passenger's gaze is directed. Meanwhile, if the XR object is output to the display provided in the self-driving vehicle 100b, at least part of the XR object may be output so as to overlap the object in the screen. For example, the self-driving vehicle 100b may output XR objects corresponding to objects such as a lane, another vehicle, a traffic light, a traffic sign, a two-wheeled vehicle, a pedestrian, a building, and the like.

If the self-driving vehicle 100b, which is subjected to control/interaction in the XR image, may acquire the sensor information from the sensors including the camera, the self-driving vehicle 100b or the XR device 100c may generate the XR image based on the sensor information, and the XR device 100c may output the generated XR image. The self-driving vehicle 100b may operate based on the control signal input through the external device such as the XR device 100c or the user's interaction.

FIG. 4 is a view for explaining the operation of an artificial intelligence apparatus according to one embodiment of the present disclosure.

As illustrated in FIG. 4, the artificial intelligence apparatus 100 of the present disclosure may include a memory 170 that stores a list of pre-learned speakers, and a processor 180 that identifies a new speaker from input utterance data.

The processor 180 preprocesses the utterance data when utterance data of a speaker 500 is input, identifies a new speaker based on the preprocessed utterance data, outputs an active query for the identified new speaker, and when response utterance data of the new speaker to the output active query is input, learns the new speaker based on the response utterance data of the new speaker and registers the new speaker in the speaker list.

Here, when preprocessing utterance data, the processor 180 can preprocess the utterance data by performing feature extraction and dimension reduction from the utterance data when the utterance data is input.

In addition, when identifying a new speaker, the processor 180 inputs preprocessed utterance data into a neural network model to configure a first node corresponding to the utterance data in an embedding space, and connects an edge between the first node and a second node that already exists in the embedding space based on the correlation between the nodes, and can identify whether the speaker of the utterance data is a new speaker based on the connection relationship of the edge.

When configuring the first node, the processor 180 can configure the currently input speaker's utterance data as a node in the form of a topological graph in the embedding space.

For example, when configuring a first node, the processor 180 may configure a new first node including the utterance data of the currently input speaker if the similarity between the utterance data of the currently input speaker and the data group of the already existing second node does not satisfy the reference condition, and may include the utterance data of the currently input speaker in the data group of the second node if the similarity between the utterance data of the currently input speaker and the data group of the already existing second node satisfies the reference condition.

Here, when configuring a new first node, the processor 180 can configure the first node based on the resonance conditions of the adaptive resonance theory (ART).

At this time, the first node is a node corresponding to the speaker's utterance data currently being input, and may include unlabeled utterance data for which the speaker's label does not exist.

In addition, the second node is a node corresponding to the utterance data of a speaker that already exists, and includes labeled utterance data in which the speaker's label exists, and can be pre-learned.

In some cases, the second node may contain unlabeled utterance data, where the speaker's label does not exist.

Next, when connecting the first node and the second node with an edge, the processor 180 can calculate a weight based on the co-activated count between the first node and the second node when the first node is configured, and can connect the first node and the second node with an edge based on the calculated weight.

In some cases, the processor 180 may not connect the edge between the first node and the second node if the calculated weight is 0.

Additionally, the processor 180 may increase the co-activated count between the first node and the second node if the similarity between the first node and the second node is high.

Here, the processor 180 can increase the edge weight connecting the first node and the second node as the co-activated count between the first node and the second node increases.

For example, when increasing the weight, the processor 180 may increase the edge weight increase rate between the first node and the second node in proportion to the increase rate of the co-activated count between the first node and the second node.

In other words, when increasing the weight, the processor 180 can increase the edge weight increase rate between the first node and the second node at the same rate as the increase rate of the co-activated count between the first node and the second node.

Additionally, when connecting an edge between a first node and a second node, the processor 180 may connect a plurality of edges to the first node if there are a plurality of second nodes that are co-activated with the first node.

For example, the number of edges connected to a first node may be equal to the number of second nodes co-activated with the first node.

Additionally, the processor 180 can assign weights to a plurality of edges connecting the first node and a plurality of second nodes based on the co-activated count between the first node and the plurality of second nodes.

Here, the weights assigned to the plurality of edges may be different according to the co-activated count between the first node and the multiple second nodes, but this is only an example and is not limited thereto.

Next, when identifying a new speaker, the processor 180 collects information on a first node and a second node connected to the edge based on the connection relationship of the edge, calculates an uncertainty score of the first node based on the collected information of the second node, and if the calculated uncertainty score is greater than or equal to a reference value, the speaker of the utterance data can be identified as a new speaker.

Here, when calculating the uncertainty score of the first node, the processor 180 can collect information of the second node based on the message passing method, update the first node based on the information of the second node, and calculate the uncertainty score of the first node by inferring the correlation between the first node and the second node.

For example, the processor 180 can identify the speaker of the utterance data as a speaker already registered in the speaker list if the calculated uncertainty score is less than a reference value.

Next, when outputting an active query, the processor 180 may select a specific active query corresponding to a new speaker from a list of pre-stored active querys and output the selected specific active query to the new speaker.

Here, the processor 180 can convert a specific active query into at least one of voice, image, and text and output it, but this is only one embodiment and is not limited thereto.

Additionally, the processor 180 can select a specific active query corresponding to a new speaker from a list of pre-stored active querys based on the uncertainty score.

For example, a list of pre-stored active querys may include a plurality of active query items, and the plurality of active query items may be classified by uncertainty score.

In some cases, the list of pre-saved active querys may place active query items with high uncertainty scores at a higher level and active query items with low uncertainty scores at a lower level.

Alternatively, a plurality of active query items may be arranged sequentially according to their uncertainty scores.

This is because, since the plurality of active query items are sequentially arranged according to uncertainty scores, not only can the required active query be accurately and quickly selected and output according to the uncertainty level of the utterance data, but also new speaker learning and speaker recognition accuracy can be improved through fast labeling processing.

Next, the processor 180 can select and extract an active query item corresponding to the calculated uncertainty score from among a plurality of active query items included in the active query list.

Here, the processor 180 may select and extract only one active query item whose uncertainty score is greater than or equal to the reference score, and may select and extract a plurality of active query items whose uncertainty score is less than the reference score, but, this is only one example and is not limited thereto.

For example, the processor 180 may increase the number of active query items selected as the uncertainty score decreases.

This is because speaker recognition accuracy can be improved through rapid labeling processing using a plurality of active querys even for utterance data with low uncertainty levels.

Next, when response utterance data of a new speaker to an active query is input, the processor 180 checks whether the response utterance data is response utterance data that satisfies the active query, and if it is response utterance data that satisfies the active query, labels the utterance data included in the first node to learn a new speaker, and registers the learned new speaker in the speaker list.

Here, the processor 180, when checking whether the response utterance data satisfies the active query, if it is not the response utterance data that satisfies the active query, can re-output the active query for a new speaker.

In addition, when response utterance data of a new speaker for a re-output active query is input, the processor 180 can check whether the response utterance data is response utterance data that satisfies the active query, and if it is not response utterance data that satisfies the re-output active query, the processor can unlabel the speaker of the utterance data included in the first node.

In some cases, when a plurality of response utterance data of a new speaker for a plurality of active querys are input, the processor 180 checks whether all of the plurality of response utterance data are response utterance data satisfying the plurality of active querys, and if all of the plurality of response utterance data are response utterance data satisfying the plurality of active querys, the processor may label the utterance data included in the first node to learn a new speaker, and register the learned new speaker in the speaker list.

Here, when the processor 180 checks whether the response utterance data satisfies a plurality of active querys, if at least one of the plurality of response utterance data is not response utterance data satisfying a plurality of active querys, the processor 180 can unlabel the speaker of the utterance data included in the first node.

In another case, when a plurality of response utterance data of a new speaker for a plurality of active querys are input, the processor 180 may check whether at least one of the plurality of response utterance data is response utterance data that satisfies the plurality of active querys, and if at least one of the plurality of response utterance data is response utterance data that satisfies the plurality of active querys, label the utterance data included in the first node to learn a new speaker, and register the learned new speaker in the speaker list.

Here, the neural network model of the present disclosure may include a Message Passing Adaptive Resonance Theory (MPART) model.

In this way, the artificial intelligence apparatus of the present disclosure can improve speaker recognition accuracy and service quality by automatically learning the utterance data of a new speaker and automatically registering the new speaker in the speaker list by providing an active query to the new speaker along with an uncertainty measure for the input utterance data.

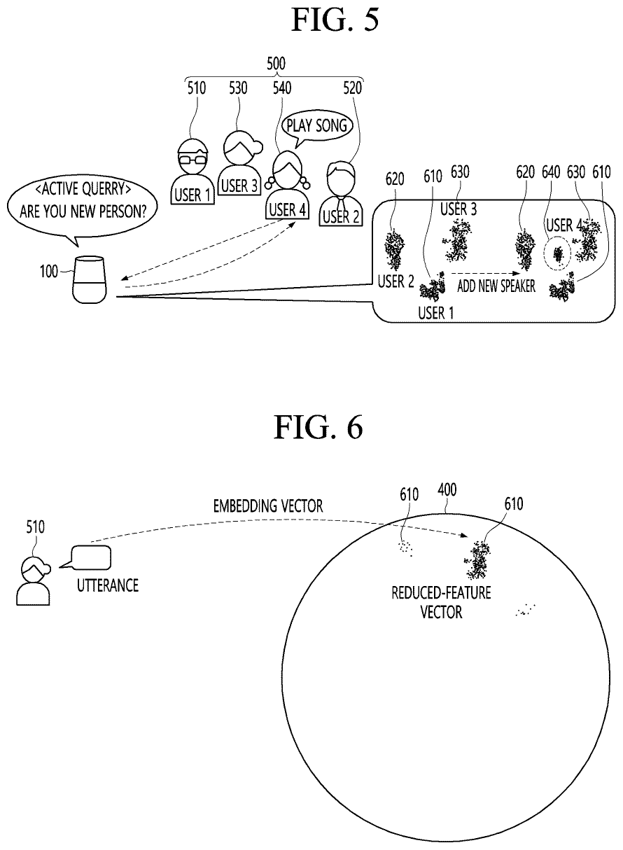

FIG. 5 is a view for explaining a method for adding a new speaker to an artificial intelligence apparatus according to an embodiment of the present disclosure.

As illustrated in FIG. 5, the artificial intelligence apparatus 100 of the present disclosure can be applied to a voice assistant system or the like to accurately identify a speaker 500 using only the speaker's utterance data 600 and provide a service desired by the speaker.

The artificial intelligence apparatus 100 of the present disclosure can increase speaker recognition accuracy based on adaptive self-learning through active querys using only a small amount of label data by using the MPART (Message Passing Adaptive Resonance Theory) model.

As illustrated in FIG. 5, when the fourth utterance data “play a song” is input from a fourth speaker 540 among a plurality of speakers 500, the artificial intelligence apparatus 100 of the present disclosure determines whether the fourth utterance data 640 of the fourth speaker 540 is different from the first utterance data 610 of the first speaker 510, the second utterance data 620 of the second speaker 520, and the third utterance data 630 of the third speaker 530 that are already registered, and if the fourth utterance data 640 of the fourth speaker 540 is different from the existing utterance data, recognizes it as new utterance data, and measures the uncertainty of the fourth utterance data 640 of the fourth speaker 540 to provide an active query to the fourth speaker 540.

For example, the artificial intelligence apparatus 100 of the present disclosure provides an active query, “Are you a new person?” to a fourth speaker 540, and when response utterance data of the fourth speaker 540 to the active query is input, the utterance data is labeled based on the response utterance data of the fourth speaker 540, and the fourth speaker 540 is learned based on the labeled utterance data, so that the fourth speaker 540 can be added as a new speaker in the speaker list.

In this way, the present disclosure can perform semi-supervised learning that can learn each speaker based on a small amount of label data.

In addition, the present disclosure automatically registers new speakers based on online learning that performs adaptive self-learning through active querys even in situations where the number of speakers using the voice service in a home environment and the total number of speakers are unknown, thereby providing voice services to new speakers at any time.

In addition, the present disclosure can perform active learning that provides active querys to a speaker while simultaneously measuring uncertainty for currently input utterance data.

In addition, the present disclosure can improve speaker recognition accuracy by automatically labeling utterance data as a speaker's response to an active query through uncertainty measurement.

FIGS. 6 to 14 are views for explaining a neural network model of an artificial intelligence apparatus according to an embodiment of the present disclosure.

The present disclosure can perform adaptive self-learning through active querys using the MPART (Message Passing Adaptive Resonance Theory) model.

As illustrated in FIG. 6, when first utterance data of a first speaker 510 is input, the present disclosure can perform feature extraction and dimension reduction on the first utterance data, and map the first utterance data 610 expressed as a reduced-dimensional feature vector to an embedding space 400.

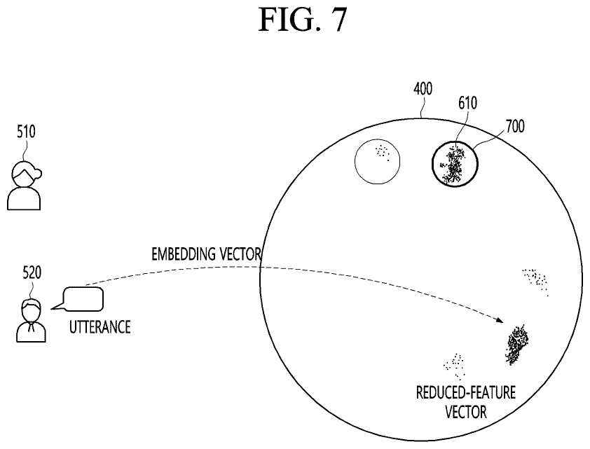

Next, as illustrated in FIG. 7, the present disclosure can configure first utterance data 610 within an embedding space 400 as a node 700 in the form of a topological graph.

In addition, in the present disclosure, when second utterance data of a second speaker 520 is input, feature extraction and dimension reduction are performed on the second utterance data, and the second utterance data 620 expressed as a dimensionally reduced-feature vector can be mapped to the embedding space 400.

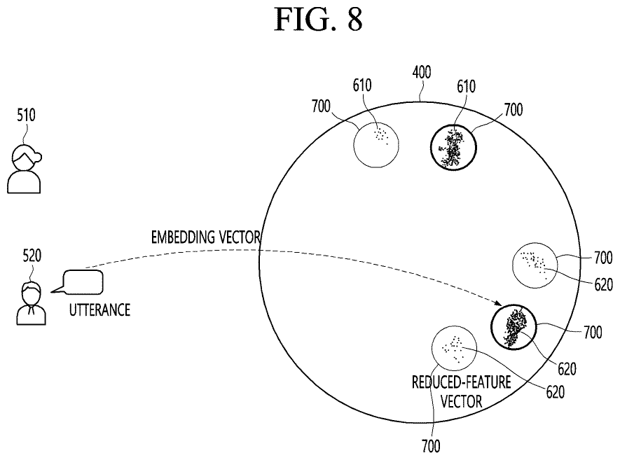

Next, as illustrated in FIG. 8, the present disclosure can configure second utterance data 620 within an embedding space 400 as a node 700 in the form of a topological graph.

In other words, in the embedding space, nodes 700 corresponding to the first utterance data 610 and nodes 700 corresponding to the second utterance data 620 can be placed.

Here, the present disclosure can configure the currently input second utterance data 620 as a new node if the currently input second utterance data 620 does not satisfy the similarity criterion condition with the first utterance data group of nodes that already exist in the embedding space 400.

In some cases, the present disclosure may update the winner node by including the currently input second utterance data 620 in the first utterance data group, which is a winner node, without configuring the currently input second utterance data 620 as a new node if the current input second utterance data 620 satisfies a similarity criterion condition with the first utterance data group of nodes that already exist in the embedding space 400.

As an example, the present disclosure may use an algorithm including the following mathematical formula 1 when configuring a node.

$${M}_{\text{?}} ( {I}_{\text{?}} ) = \frac{{‖ {I}_{\text{?}} ∧ {w}_{\text{?}} ‖}_{1}}{{‖ {I}_{\text{?}} ‖}_{1}} , \qquad [ Mathematical Formula 1 ]$$

$${T}_{\text{?}} ( {I}_{\text{?}} ) = \frac{{‖ {I}_{\text{?}} ∧ {w}_{\text{?}} ‖}_{1}}{α + {‖ {w}_{\text{?}} ‖}_{1}}$$

$$\text{?} \text{indicates text missing or illegible when filed}$$

Here, Mj is a matching function, Tj is a choice function, \hat{ } denotes an element-wise minimum operation, ∥·∥₁ is L1 regularization, α>0 is a hyperparameter for the choice function, and the input Iₜ is [rₜ, 1−rₜ], where rₜ can be a reduced-dimensional feature vector.

At this time, the input Iₜ can be compared with all nodes j to obtain the matching function Mⱼ(Iₜ).

In addition, the matching function Mⱼ(Iₜ) can be a winner node candidate if it is greater than or equal to the vigilance parameter ρ∈[0, 1].

Next, the final winner node Jₜ can be selected as the node among the winner node candidates whose selection function Tⱼ(Iₜ) has the largest value, and the remaining nodes can be co-activated nodes.

Additionally, the winner node can be updated with a learning rate β∈[0,1] and increase the winning count d_{Jt} by the following mathematical formula 2.

$${w}_{{J}_{\text{?}}}^{n e w} = β ( {I}_{\text{?}} ∧ {w}_{{J}_{\text{?}}}^{old} ) + ( 1 - β ) {w}_{{J}_{\text{?}}}^{new} \qquad [ Mathematical Formula 2 ]$$

$${d}_{{{J}_{\text{?}}}^{}}^{new} = {d}_{{J}_{\text{?}}}^{old} + 1$$

$$\text{?} \text{indicates text missing or illegible when filed}$$

Here, if there is no winner node, a new node Jₜ is created, and the new node can be initialized with w_{Jt}=Iₜ and d_{Jt}=1.

In this way, the present disclosure can configure nodes based on the resonance conditions of the adaptive resonance theory (ART) when configuring nodes.

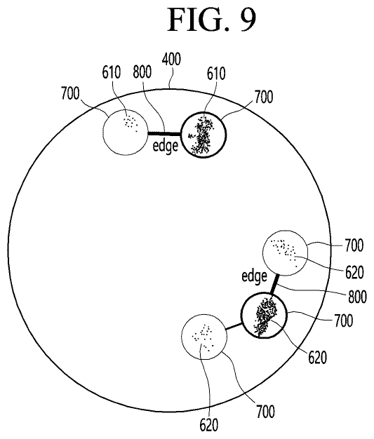

Next, as illustrated in FIG. 9, the present disclosure can connect nodes 700 with edges 800 based on the correlation between nodes 700.

Here, the present disclosure calculates weights based on the co-activated count between nodes 700, and can connect the calculated weights between nodes 700 as edges 800.

For example, the present disclosure may not connect nodes 700 with an edge if the calculated weight is 0.

The present disclosure can increase the co-activated count between nodes when the similarity between nodes 700 is high, and as the co-activated count between nodes 700 increases, the weight of the edge 800 connecting the nodes 700 can be increased.

As an example, the present disclosure can increase the edge 800 weight increase rate in proportion to the increase rate of the co-activated count between nodes 700.

As another example, the present disclosure may increase the edge (700 weight increase rate at the same rate as the increase rate of the co-activated count between nodes 700.

Additionally, the present disclosure may be connected to an edge 800 by a plurality of nodes 700 that are co-activated to one node 700.

Here, the number of edges 800 connected to one node 700 may be equal to the number of co-activated nodes 700, but this is only one embodiment and is not limited thereto.

In addition, the present disclosure can assign different weights to each edge 800 connecting nodes 700 based on the co-activated count between nodes 700.

In other words, the weight assigned to the edge 800 may be different according to the co-activated count between nodes 700.

In this way, when a plurality of nodes 700 are activated, the co-activated count cJₜv between the winner node Jₜ and the co-activated nodes v≠Jₜ can increase by 1.

Next, the edge weight eᵢⱼ of the topological graph can be defined by the following mathematical formula 3.

$${e}_{ij} = {c}_{ij} / ( {d}_{\text{?}} + {d}_{j} ) \qquad [ Mathematical Formula 3 ]$$

$$\text{?} \text{indicates text missing or illegible when filed}$$

Here, cᵢⱼ is the co-activated count of nodes i and j, and the edge weight eᵢⱼ is between 0 and 1, and the edge weight can be used for message passing in the topological graph without normalization.

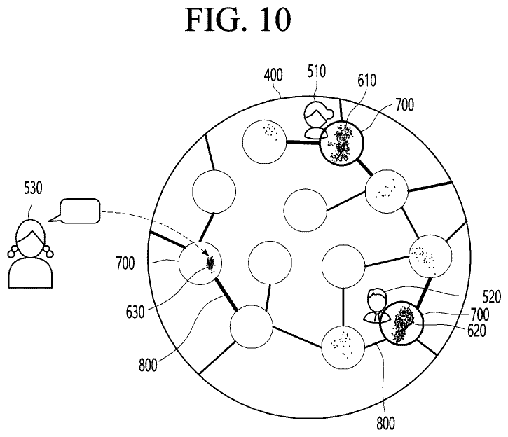

Next, as illustrated in FIG. 10, the present disclosure can identify speakers of utterance data based on the edge 800 connection relationship of nodes 700, and perform self-learning and speaker registration of a first speaker 510 corresponding to first utterance data 610 and a second speaker 520 corresponding to second utterance data 620.

In addition, when the third utterance data of a new third speaker 520 is input, feature extraction and dimension reduction are performed on the new third utterance data, and the third utterance data 630 expressed as a dimensionally reduced-feature vector can be mapped to the embedding space 400.

In addition, the present disclosure can configure the currently input third utterance data 630 as a new node if the similarity between the currently input third utterance data 630 and the data group, such as the first utterance data 610 and the second utterance data 620, which are included in the node that already exists in the embedding space 400 is different.

Next, the present disclosure calculates weights based on the number of times of co-activation between nodes 700, and connects new nodes 700 corresponding to third utterance data 630 and other existing nodes 700 as edges 800 based on the calculated weights.

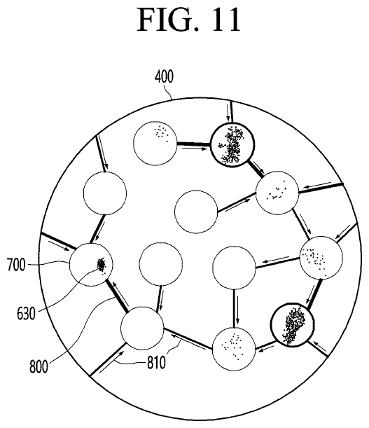

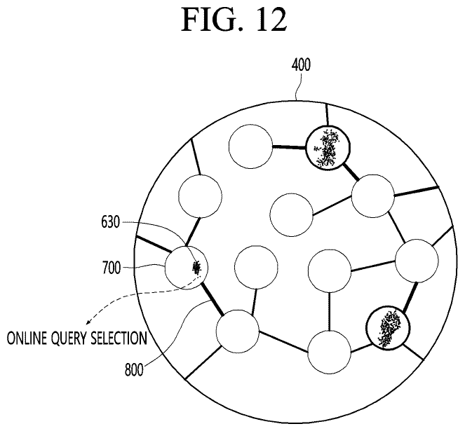

Next, as illustrated in FIG. 11 and FIG. 12, the present disclosure can identify whether the speaker of the third utterance data 630 is a new speaker based on the connection relationship of the edge 800.

Here, the present disclosure collects information on a new node and an existing node connected to the edge 800 based on the connection relationship of the edge 800, calculates an uncertainty score of the new node based on the information of the collected existing node, if the calculated uncertainty score is greater than or equal to a reference value, identifies the speaker corresponding to the third utterance data 630 as a new speaker, and if the calculated uncertainty score is less than the reference value, the speaker of the third utterance data 630 can be identified as an existing speaker pre-registered in the speaker list.

At this time, the present disclosure can collect information on existing nodes based on the message passing 810 method when calculating the uncertainty score of a new node, update the new node based on the information on the existing node, and calculate the uncertainty score of the new node by inferring the correlation between the new node and the existing node.

In this way, the present disclosure can define a message passing 810 method for node identification using the following mathematical formula 4.

$${X}_{\text{?}}^{( \text{?} )} = {X}_{\text{?}}^{( \text{?} - 1 )} + δ {\sum }_{j ∈ {N}_{\text{?}}} {e}_{ij} {X}_{\text{?}}^{( \text{?} - 1 )} , ∀ i ∈ {N}_{{J}_{\text{?}}}^{( 0 : L - \text{?} )} \qquad [ Mathematical Formula 4 ]$$

$$\text{?} \text{indicates text missing or illegible when filed}$$

Here, δ∈[0, 1] is a hyperparameter of the propagation rate, Xᵢ and Xⱼ are information vectors such as label density and winning count, and Ni can be a set of all neighboring nodes of the node.

This message passing method can be used repeatedly across a plurality of layers to collect a wider range of information.

In this way, the present disclosure can use the node information

$${X}_{\text{?}}^{( L )}$$

$$\text{?} \text{indicates text missing or illegible when filed}$$

of the final layer L to perform a desired task.

In addition, the present disclosure can identify the speaker of input utterance data xₜ by estimating the class label of the winner node Jₜ.

As an example, the present disclosure can increase the label density qJₜ(yₜ) by 1 when a label yₜ is received at a winner node.

Here, a node class can be evaluated not only by the label of the node containing the currently input utterance data, but also by the labels of the surrounding nodes that are rarely given.

The class probability distribution pₜ(y) and the estimated speaker \hat{ }y of the currently input utterance data xᵢ can be obtained using the aggregated label density

$${q}_{{J}_{\text{?}}}^{( L )}$$

$$\text{?} \text{indicates text missing or illegible when filed}$$

as in the following mathematical formula 5.

$$\text{?} \qquad [ Mathematical Formula 5 ]$$

$$\text{?} \text{indicates text missing or illegible when filed}$$

Here, C can be a set of labels of already known speakers.

Additionally, the present disclosure can select representative utterance data samples for speaker identification using the aggregated winning count

$${d}_{{J}_{\text{?}}}^{( L )}$$

$$\text{?} \text{indicates text missing or illegible when filed}$$

of the winner node Jₜ.

Here, the aggregated winning count

$${d}_{{J}_{\text{?}}}^{( L )}$$

$$\text{?} \text{indicates text missing or illegible when filed}$$

can increase as the number of input utterance data samples that activate the winner node J and its surrounding nodes increases.

Therefore, the aggregated winning count

$${d}_{{J}_{\text{?}}}^{( L )}$$

$$\text{?} \text{indicates text missing or illegible when filed}$$

may have a large value at the center of the feature vector distribution for a given speaker.

Therefore, the present disclosure can define a density score sₜ of an input utterance data sample xₜ using the aggregated winning count

$${d}_{{J}_{\text{?}}}^{( L )}$$

$$\text{?} \text{indicates text missing or illegible when filed}$$

as in the following mathematical formula 6.

$${s}_{\text{?}} = tanh ( {k}_{d} \cdot {d}_{{J}_{\text{?}}}^{L} ) \qquad [ Mathematical Formula 6 ]$$

$$\text{?} \text{indicates text missing or illegible when filed}$$

Here, k_{d}>0 can be a constant for sensitivity.

In addition, the present disclosure can query a representative sample by selecting input utterance data samples whose density score sₜ is greater than a density threshold θd ∈[0, 1].

In addition, the present disclosure can calculate an uncertainty score uₜ, which can be viewed as an epistemological uncertainty, by using the label density

$${q}_{{J}_{\text{?}}}^{( L )}$$

$$\text{?} \text{indicates text missing or illegible when filed}$$

of the winner node Jₜ, as in the following mathematical formula 7.

$${u}_{\text{?}} = 1 - tanh ( {k}_{u} {\sum }_{y ∈ C} {q}_{{J}_{\text{?}}}^{( J )} ( y ) \qquad [ Mathematical Formula 7 ]$$

$$\text{?} \text{indicates text missing or illegible when filed}$$

Here, kᵤ>0 can be a sensitivity constant for the uncertainty score uₜ.

Additionally, the uncertainty score uₜ can have high values in areas with few labels among the input utterance data distribution.

Therefore, the present disclosure can query informative samples by selecting input utterance data samples having an uncertainty score uₜ larger than an uncertainty threshold θᵤ.

In this way, the present disclosure can utilize the density score sₜ and the uncertainty score uₜ, respectively, for query selection.

In conclusion, the present disclosure can obtain labels by querying input utterance data samples satisfying both the conditions that the density score is sₜ>θ_{d} and the uncertainty score is uₜ>θᵤ, and gradually improve the speaker recognition performance.

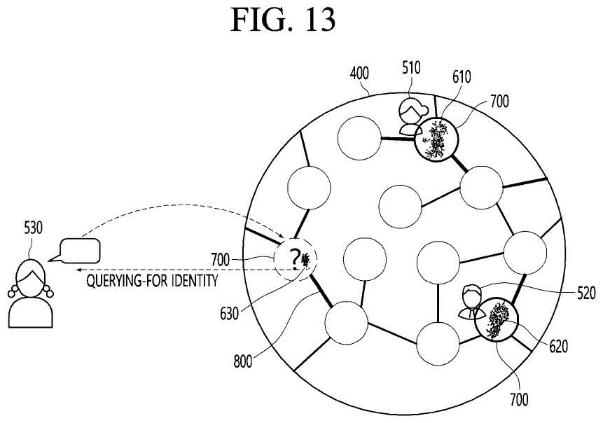

As illustrated in FIG. 13 below, the present disclosure can output an active query for identification to a new third speaker 530 corresponding to the third utterance data 630 based on the density score and the uncertainty score.

As an example, the present disclosure may select a specific active query corresponding to a new speaker from a list of stored active querys, and output the selected specific active query to the new speaker.

Here, the present disclosure can output a specific active query by converting it into at least one of voice, image, and text, but this is only an example and is not limited thereto.

Additionally, the present disclosure can select a specific active query corresponding to a new speaker from a list of pre-stored active querys based on the uncertainty score.

For example, a list of pre-stored active querys may include multiple active query items, and the multiple active query items may be classified by uncertainty score.

In some cases, the list of pre-stored active querys may place active query items with high uncertainty scores at a higher level and active query items with low uncertainty scores at a lower level.

Alternatively, a plurality of active query items may be arranged sequentially according to their uncertainty scores.

This is because, since the plurality of active query items are sequentially arranged according to uncertainty scores, not only can the required active query be accurately and quickly selected and output according to the uncertainty level of the utterance data, but also new speaker learning and speaker recognition accuracy can be improved through fast labeling processing.

Next, the present disclosure can select and extract an active query item corresponding to the calculated uncertainty score from among a plurality of active query items included in the active query list.

Here, the present disclosure can select and extract only one active query item whose uncertainty score is greater than or equal to a reference score, and can select and extract a plurality of active query items whose uncertainty score is less than the reference score, but this is only an example and is not limited thereto.

For example, the present disclosure may increase the number of active query items selected as the uncertainty score decreases.

This is because speaker recognition accuracy can be improved through rapid labeling processing using a plurality of active querys even for utterance data with low uncertainty levels.

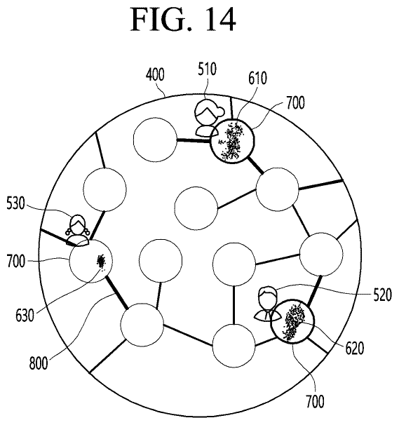

Next, as illustrated in FIG. 14, when response utterance data of a third speaker 530 to an active query is input, the present disclosure can check whether the response utterance data is response utterance data that satisfies the active query, and if it is response utterance data that satisfies the active query, label the third utterance data 630 to learn a new third speaker 530, and register the learned new third speaker 530 in the speaker list.

Here, the present disclosure can re-output an active query to a third speaker 530 when checking whether the response utterance data satisfies an active query.

In addition, in the present disclosure, when response utterance data of a third speaker 530 to a re-output active query is input, it can be checked whether the response utterance data is response utterance data that satisfies the active query, and if it is not response utterance data that satisfies the re-output active query, the third utterance data 630 can be unlabeled.

In some cases, the present disclosure may, when a plurality of response utterance data of a third speaker 530 for a plurality of active querys are input, check whether all of the plurality of response utterance data are response utterance data that satisfy the plurality of active querys, and if all of the plurality of response utterance data are response utterance data that satisfy the plurality of active querys, label the third utterance data 630 to learn the third speaker 530, and register the new third speaker 530 that has been learned in the speaker list.

Here, the present disclosure can unlabel third utterance data 630 when verifying whether the plurality of response utterance data are response utterance data satisfying a plurality of active querys, if at least one of the plurality of response utterance data is not response utterance data that satisfies a plurality of active querys.

In another case, the present disclosure may check whether at least one of the plurality of response utterance data is response utterance data that satisfies the plurality of active querys when a plurality of response utterance data of a new speaker for a plurality of active querys is input, and if at least one of the plurality of response utterance data is response utterance data that satisfies the plurality of active querys, label the utterance data to learn a new speaker, and register the learned new speaker in a speaker list.

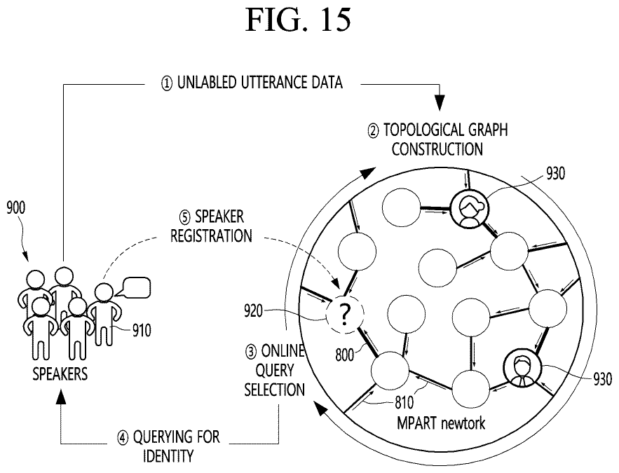

FIG. 15 is a view for explaining a new speaker registration process of an artificial intelligence apparatus according to one embodiment of the present disclosure.

As illustrated in FIG. 15, the present disclosure can preprocess unlabeled utterance data to form a first node 920 within an embedding space if the unlabeled utterance data is input from the plurality of speakers 900.

Here, the present disclosure, when configuring the first node 920, if the utterance data of the currently input speaker does not satisfy a similarity criterion condition with respect to a data group of a second node 930 where the utterance data of the currently input speaker already exists, configures a new first node 920, and if the utterance data of the currently input speaker satisfies a similarity criterion condition with respect to a data group of a second node 930 where the utterance data of the currently input speaker already exists, the utterance data of the currently input speaker can be included as a data group of the second node 930.

As an example, the present disclosure can configure a first node 920 based on the resonance conditions of the adaptive resonance theory (ART) when configuring a new first node 920.

Additionally, the first node 920 may include unlabeled utterance data of the speaker 900.

Additionally, the second node 930 that already exists may include labeled utterance data of the speaker 900 and may be pre-learned.

In some cases, the already existing second node 930 may include unlabeled utterance data of the speaker 900.

In addition, the present disclosure connects a first node 920 and a second node 930 that already exists in the embedding space with an edge 800 based on the correlation between nodes, and can identify whether a speaker 900 of utterance data is a new speaker 910 based on the connection relationship of the edge 800.

Here, the present disclosure can calculate a weight based on the co-activated count between the currently configured first node 920 and the previously configured second node 930 when the first node 920 is configured, and connect the first node 920 and the second node 930 with an edge 800 based on the calculated weight.

For example, the present disclosure may not connect the first node 920 and the second node 930 with an edge 800 if the calculated weight is 0.

Additionally, the present disclosure can increase the co-activated count between the first node 920 and the second node 930 when the similarity between the first node 920 and the second node 930 is high.

Here, the present disclosure can increase the edge weight connecting the first node 920 and the second node 930 as the co-activated count between the first node 920 and the second node 930 increases.

In addition, the present disclosure can collect information on a second node 930 connected to a first node 920 with an edge based on the connection relationship of an edge 800 when identifying a new speaker 910, calculate an uncertainty score of the first node 920 based on the collected information of the second node 930, and if the calculated uncertainty score is greater than or equal to a reference value, the speaker 900 of the utterance data can be identified as a new speaker 910.

Here, the present disclosure, when calculating an uncertainty score of a first node 920, if collecting information of a second node 930 based on a message passing 810 method, can update the first node 920 based on the information of the second node 930, and calculate the uncertainty score of the first node 920 by inferring a correlation between the first node 920 and the second node 930.

At this time, the present disclosure can identify the speaker 900 of the utterance data as a speaker 900 pre-registered in the speaker list if the calculated uncertainty score is less than a reference value.

Next, the present disclosure outputs an active query for a new speaker 910, and when response utterance data of the new speaker 910 to the output active query is input, the new speaker 910 can be learned based on the response utterance data of the new speaker 910 and registered in the speaker list.

Here, the present disclosure can select a specific active query corresponding to a new speaker 910 from a list of pre-stored active querys when outputting an active query, and output the selected specific active query to the new speaker 910.

In some cases, the present disclosure may also select a particular active query corresponding to a new speaker 910 from a list of pre-stored active querys based on the uncertainty score.

For example, a list of pre-stored active querys may include a plurality of active query items, and the plurality of active query items may be classified by uncertainty score.

Here, the present disclosure can select and extract an active query item corresponding to the calculated uncertainty score from among a plurality of active query items included in the active query list.

Next, the present disclosure can check whether the response utterance data is response utterance data that satisfies the active query when response utterance data of a new speaker 910 to an active query is input, and if it is response utterance data that satisfies the active query, label the utterance data included in the first node 920 to learn a new speaker 910, and register the learned new speaker 910 in a speaker list.

Here, the present disclosure can re-output an active query for a new speaker 910 when checking whether the response utterance data satisfies the active query.

In addition, the present disclosure can check whether the response utterance data is response utterance data that satisfies the active query when response utterance data of a new speaker 910 to a re-output active query is input, and if it is not response utterance data that satisfies the re-output active query, the speaker 900 of the utterance data included in the first node 920 can be unlabeled.

In some cases, the present disclosure, when a plurality of response utterance data of a new speaker 910 for a plurality of active querys are input, can check whether all of the plurality of response utterance data are response utterance data that satisfies the plurality of active querys, and if all of the plurality of response utterance data are response utterance data that satisfies the plurality of active querys, label the utterance data included in the first node 920 to learn a new speaker 910, and register the learned new speaker 910 in the speaker list.

In another case, the present disclosure, when a plurality of response utterance data of a new speaker for a plurality of active querys are input, can check whether at least one of the plurality of response utterance data is response utterance data that satisfies the plurality of active querys, and if at least one of the plurality of response utterance data is response utterance data that satisfies the plurality of active querys, label the utterance data included in the first node 920 to learn a new speaker, and register the learned new speaker in the speaker list.

The neural network model used in the present disclosure may include a Message Passing Adaptive Resonance Theory (MPART) model.

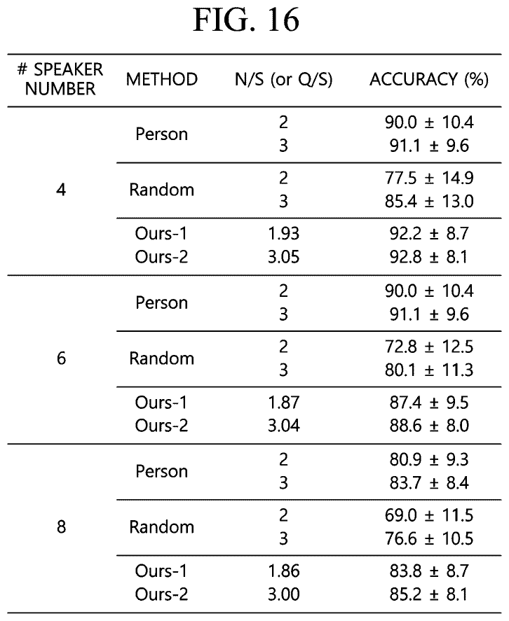

FIGS. 16 to 18 are views illustrating speaker recognition accuracy performance results for a neural network model of an artificial intelligence apparatus according to an embodiment of the present disclosure.

FIG. 16 is a view illustrating the speaker recognition accuracy of the present disclosure as the number of speakers increases.

As illustrated in FIG. 16, as a comparison method for the present disclosure, the person method is a numerical value illustrating speaker recognition accuracy when the same number of label data samples are given to each speaker, and the random method is a numerical value illustrating speaker recognition accuracy when label data samples are randomly given to speakers in a home environment.

Here, it can be seen that the speaker recognition accuracy of the person method and the random method increases as the number of label data samples per speaker (N/S) increases, but the speaker recognition accuracy is lower than that of the method of the present disclosure.

The method (ours) of the present disclosure is a method in which active querys are given to an estimated speaker through an unlabeled data sample, and may include a first method (our-1) in which the provision rate (Q/S) of active querys given to an identified speaker is low, and a second method (our-2) in which the provision rate (Q/S) of active querys given to an identified speaker is high.

Here, it can be seen that the method (ours) of the present disclosure improves speaker recognition accuracy more significantly than the person method and the random method, and among the methods of the present disclosure, it can be seen that the speaker recognition accuracy of the second method, which has a higher active query provision rate than the first method, is improved more.

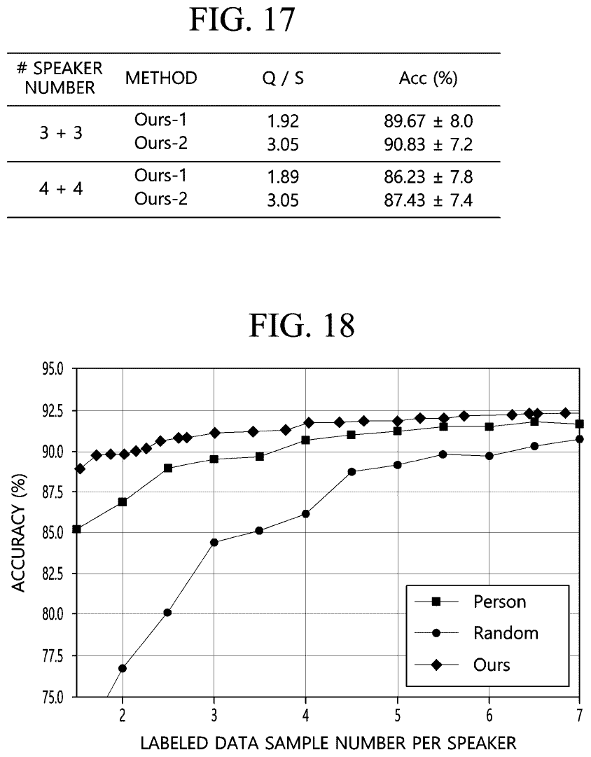

FIG. 17 is a diagram illustrating the speaker recognition accuracy of the present disclosure for a speaker group added first and a speaker group joined later, in which an active query provision test is performed on the speaker group added first and then an active query provision test is performed on the speaker group joined later, thereby illustrating the robustness of the present disclosure against the forgetting phenomenon.

As illustrated in FIG. 17, the first method (our-1) of the present disclosure having a low rate of active querys (Q/S) given to the identified speaker, and the second method (our-2) of the present disclosure having a high rate of active querys (Q/S) given to the identified speaker, can be seen to have high speaker recognition accuracy and thus excellent robustness against the forgetting phenomenon.

In addition, it can be seen that among the methods of the present disclosure, the second method, which has a higher rate of active query provision than the first method, has better robustness against the forgetting phenomenon.

FIG. 18 is a graph illustrating speaker recognition accuracy as the number of label data samples per speaker increases.

As illustrated in FIG. 18, the person method is a method in which the same number of label data samples are given to each speaker, the random method is a method in which label data samples are randomly given to speakers within a home environment, and the method of the present disclosure is a method in which active querys are given to speakers estimated through unlabeled data samples.

Here, it can be seen that the speaker recognition accuracy of the method of the present disclosure, the person method, and the random method all increase as the number of label data samples per speaker increases, but it can be seen that the method of the present disclosure has the best speaker recognition accuracy compared to the person method and the random method.

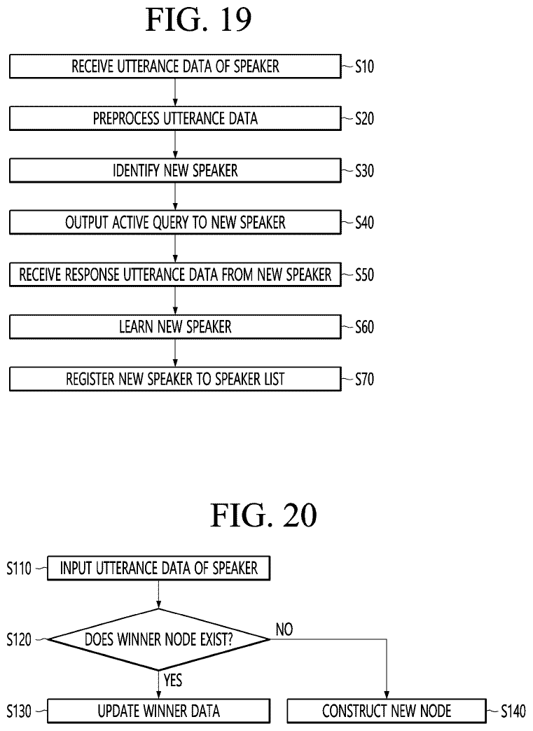

FIG. 19 and FIG. 20 are views for explaining the overall operation flow of an artificial intelligence apparatus according to one embodiment of the present disclosure.

As illustrated in FIG. 19, the present disclosure can receive a speaker's utterance data (S10).

In addition, the present disclosure can preprocess the speaker's utterance data (S20).

Here, the present disclosure can perform feature extraction and dimension reduction from utterance data.

Next, the present disclosure can identify a new speaker based on preprocessed utterance data (S30).

Here, the present disclosure can input preprocessed utterance data into a neural network model to form a first node corresponding to the utterance data within an embedding space, connect the first node and a second node that already exists in the embedding space with an edge based on a correlation between the nodes, and identify whether the speaker of the utterance data is a new speaker based on the connection relationship of the edge.

For example, the present disclosure may configure a new first node including the currently input speaker's utterance data if the currently input speaker's utterance data does not satisfy a similarity criterion condition with a data group of a second node that already exists, and may include the currently input speaker's utterance data as a data group of the second node if the currently input speaker's utterance data satisfies a similarity criterion condition with a data group of a second node that already exists.

In addition, the present disclosure can calculate a weight based on the co-activated count between the first node and the second node when the first node is configured, and connect the first node and the second node with an edge based on the calculated weight.

In addition, the present disclosure can collect information on a first node and a second node connected with the edge based on the connection relationship of the edge, calculate an uncertainty score of the first node based on the collected information of the second node, and if the calculated uncertainty score is greater than or equal to a reference value, the speaker of the utterance data can be identified as a new speaker.

Here, the present disclosure, when collecting information of a second node based on a message passing method, can update a first node based on the information of the second node, and infer a correlation between the first node and the second node to calculate an uncertainty score of the first node.

Next, the present disclosure can output an active query for a new speaker when the new speaker is identified (S40).

Here, the present disclosure can select a specific active query corresponding to a new speaker from a list of pre-stored active querys, and output the selected specific active query to the new speaker.

As an example, the present disclosure can output a specific active query by converting it into at least one of voice, image, and text.

In addition, the present disclosure can receive the response utterance data of a new speaker for an active query (S50).

Next, the present disclosure can learn a new speaker based on the response utterance data of the new speaker (S60).

Next, the present disclosure can register a learned new speaker in a speaker list (S70).

Here, the present disclosure can check whether the response utterance data is response utterance data that satisfies the active query when response utterance data of a new speaker to an active query is input, and if it is response utterance data that satisfies the active query, label the utterance data included in the first node to learn a new speaker, and register the learned new speaker in a speaker list.

In some cases, the present disclosure may re-output the active query to a new speaker if the response utterance data does not satisfy the active query.

Here, the present disclosure can check whether the response utterance data is response utterance data that satisfies the active query when response utterance data of a new speaker for a re-output active query is input, and if it is not response utterance data that satisfies the re-output active query, the speaker of the utterance data included in the first node can be unlabeled.

In addition, as illustrated in FIG. 20, the present disclosure can configure nodes based on resonance conditions of the adaptive resonance theory (ART) when configuring nodes.

In the present disclosure, when utterance data of a speaker is input (S110), can determine whether a winner node exists among existing nodes (S120).

In addition, the present disclosure can update the winner node by joining the currently input utterance data of the speaker to the winner node if a winner node exists (S130).

In addition, the present disclosure can configure a new node corresponding to the currently input the utterance data of the speaker if a winner node does not exist (S140).

In this way, the present disclosure can improve speaker recognition accuracy and service quality by automatically learning the utterance data of a new speaker and automatically registering the new speaker in the speaker list by providing an active query to the new speaker along with an uncertainty measure for the input utterance data.

The above-described present disclosure can be implemented as a computer-readable code on a medium in which a program is recorded. The computer-readable medium includes all kinds of recording devices in which data that can be read by a computer system is stored. Examples of the computer-readable medium may include a hard disk drive (HDD), a solid state disk (SSD), a silicon disk drive (SDD), a ROM, a RAM, a CD-ROM, a magnetic tape, a floppy disk, an optical data storage device, or the like. In addition, the computer may include a processor 180 of an artificial intelligence apparatus.

### INDUSTRIAL APPLICABILITY

The artificial intelligence apparatus according to the present disclosure has remarkable industrial applicability because it has the effect of improving speaker recognition accuracy and service quality by automatically learning the utterance data of a new speaker and automatically registering the new speaker in a speaker list by providing an active query to a new speaker together with an uncertainty measurement for input utterance data.

1. An artificial intelligence apparatus comprises:
a memory storing a list of pre-learned speakers; and,
a processor identifying a new speaker from input utterance data,
wherein the processor preprocesses the utterance data when the utterance data is input, identifies a new speaker based on the pre-processed utterance data, outputs an active query for the identified new speaker, and when response utterance data of the new speaker to the output active query is input, learns the new speaker based on the response utterance data of the new speaker and registers the new speaker in the speaker list.

2. The artificial intelligence apparatus of claim 1,
wherein the processor, when preprocessing the utterance data, if the utterance data is input, performs feature extraction and dimension reduction from the utterance data to preprocess it.

3. The artificial intelligence apparatus of claim 2,
wherein the processor, when identifying the new speaker, inputs the preprocessed utterance data into a neural network model to configure a first node corresponding to the utterance data in an embedding space, and connects an edge between the first node and a second node that already exists in the embedding space based on a correlation between nodes, and identifies whether the speaker of the utterance data is a new speaker based on the connection relationship of the edge.

4. The artificial intelligence apparatus of claim 3,
wherein the processor,
when configuring the first node, if the currently input speaker's utterance data does not satisfy the similarity criterion condition with the data group of the second node where the current input speaker's utterance data already exists, configures a new first node including the currently input speaker's utterance data, and if the currently input speaker's utterance data satisfies the similarity criterion condition with the data group of the second node where the current input speaker's utterance data already exists, includes the currently input speaker's utterance data as the data group of the second node.

5. The artificial intelligence apparatus of claim 3,
wherein the processor, when connecting the first node and the second node with an edge, if the first node is configured, a weight is calculated based on the co-activated count between the first node and the second node, and the first node and the second node are connected with an edge based on the calculated weight.

6. The artificial intelligence apparatus of claim 5,
wherein the processor does not connect the first node and the second node with an edge if the calculated weight is 0.

7. The artificial intelligence apparatus of claim 5,
wherein the processor, if the similarity between the first node and the second node is high, the number of times of co-activation between the first node and the second node is increased.

8. The artificial intelligence apparatus of claim 3,
wherein the processor, when identifying the new speaker, collects information of the second node connected to the first node by the edge based on the connection relationship of the edge, calculates an uncertainty score of the first node based on the collected information of the second node, and identifies the speaker of the utterance data as a new speaker if the calculated uncertainty score is greater than or equal to a reference value.

9. The artificial intelligence apparatus of claim 8,
wherein the processor, when calculating the uncertainty score of the first node, if collecting information of the second node based on the message passing method, updates the first node based on the information of the second node, and calculates the uncertainty score of the first node by inferring the correlation between the first node and the second node.

10. The artificial intelligence apparatus of claim 8,
wherein the processor, if the calculated uncertainty score is less than a reference value, the speaker of the utterance data is identified as a speaker registered in the speaker list.

11. The artificial intelligence apparatus of claim 1,
wherein the processor, when outputting the active query, selects a specific active query corresponding to the new speaker from a list of pre-stored active querys, and outputs the selected specific active query to the new speaker.

12. The artificial intelligence apparatus of claim 1,
wherein the processor, when a new speaker's response utterance data to the active query is input, checks whether the response utterance data is response utterance data that satisfies the active query, and if it is response utterance data that satisfies the active query, labels the utterance data included in the first node to learn the new speaker, and registers the learned new speaker in the speaker list.

13. The artificial intelligence apparatus of claim 12,
wherein the processor, when checking whether the response utterance data satisfies the active query, if the response utterance data does not satisfy the active query, re-outputs the active query for the new speaker.

14. The artificial intelligence apparatus of claim 13,
wherein the processor, when a new speaker's response utterance data to the re-outputted active query is input, checks whether the response utterance data is response utterance data satisfying the active query, and if it is not response utterance data satisfying the re-outputted active query, unlabels the speaker of the utterance data included in the first node.

15. A method for automatically recognizing speaker of an artificial intelligence apparatus, comprising:
inputting a speaker's utterance data;
preprocessing the speaker's utterance data;
identifying a new speaker based on the preprocessed utterance data;
outputting an active query for the new speaker if the new speaker is identified;
inputting the new speaker's response utterance data for the active query;
learning the new speaker based on the new speaker's response utterance data; and
registering the learned new speaker in a speaker list.
